(19) United States
(12) Patent Application Publication
(10) Pub. No.: US 2024/0275887 A1
(43) Pub. Date: Aug. 15, 2024

(54) CONGESTION CONTROL METHOD AND APPARATUS, DEVICE, MEDIUM, CHIP, PRODUCT, AND PROGRAM

(71) Applicant: GUANGDONG OPPO MOBILE TECECOMMUNICATIONS CORP,. LTD., Dongguan (CN)

(72) Inventors: Yali GUO, Dongguan (CN); Qianxi LU, Dongguan (CN); Cong SHI, Dongguan (CN)

(73) Assignee: GUANGDONG OPPO MOBILE TELECOMMUNICATIONS CORP,. LTD., Dongguan (CN)

(21) Appl. No.: 18/641,159

(22) Filed: Apr. 19, 2024

Related U.S. Application Data
(63) Continuation of application No. PCT/CN2021/135697, filed on Dec. 6, 2021.

(51) Int. Cl. H04M 15/00; H04W 28/02

(52) U.S. Cl. CPC H04M 15/66; H04M 15/8016; H04W 28/0268; H04W 28/0289

(57) ABSTRACT

Provided are methods and an apparatuses for congestion control. In an apparatus for congestion control, which includes a processor and a processor, the transceiver is configured to receive a policy and charging control (PCC) rule from a policy control function (PCF) network element, where the PCC rule includes a first congestion control indication; and the processor is configured to determine a quality of service (QOS) flow for transmitting a first service data flow based on the first congestion control indication. The transceiver is also configured to send a congestion control indication associated with the QoS flow and a QoS flow identifier of the QoS flow to an access network device.

### CROSS-REFERENCE TO RELATED APPLICATION

This is a continuation application of International Patent application No. PCT/CN2021/135697 filed on Dec. 6, 2021, the content of which is incorporated by reference in its entirety.

### BACKGROUND

Wireless resources are very valuable in wireless communications, and those skilled in the art have been focusing on improving performance of information transmission, to provide better services for users.

Congestion control is an important method to improve the performance of information transmission, and how to improve effectiveness of the congestion control is an urgent problem to be solved in this field.

### SUMMARY

Embodiments of the disclosure relate to the technical field of mobile communications. Embodiments of the disclosure provide a method and apparatus for congestion control, a device, a medium, a chip, a product, and a program.

In a first aspect, there is provided a method for congestion control in an embodiment of the disclosure, the method includes the following operations.

A session management function (SMF) network element receives a policy and charging control (PCC) rule from a policy control function (PCF) network element. The PCC rule includes a first congestion control indication.

The SMF network element determines a quality of service (QOS) flow for transmitting a first service data flow based on the first congestion control indication.

The SMF network element sends a congestion control indication associated with the QoS flow and a QoS flow identifier of the QoS flow to an access network device.

In a second aspect, there is provided a method for congestion control in an embodiment of the disclosure, the method includes the following operations.

An access network device receives a congestion control indication associated with a QoS flow and a QoS flow identifier of the QoS flow from an SMF network element.

The access network device enables congestion control on the QoS flow.

In a third aspect, there is provided a method for congestion control in an embodiment of the disclosure, the method includes the following operation.

A PCF network element sends a PCC rule to an SMF network element. The PCC rule includes a first congestion control indication.

In a fourth aspect, there is provided an apparatus for congestion control in an embodiment of the disclosure, the apparatus includes a transceiver and a processor.

The transceiver is configured to receive a PCC rule from a PCF network element. The PCC rule includes a first congestion control indication.

The processor is configured to determine a QoS flow for transmitting the first service data flow based on the first congestion control indication.

The transceiver is further configured to send a congestion control indication associated with the QoS flow and a QoS flow identifier of the QoS flow to an access network device.

In a fifth aspect, there is provided an apparatus for congestion control in an embodiment of the disclosure, the apparatus includes a transceiver and a processor.

The transceiver is configured to receive a congestion control indication associated with a QoS flow and a QoS flow identifier of the QoS flow from an SMF network element.

The processor is configured to enable congestion control on the QoS flow.

In a sixth aspect, there is provided an apparatus for congestion control in an embodiment of the disclosure, the apparatus includes a transceiver.

The transceiver is configured to send a PCC rule to an SMF network element. The PCC rule includes a first congestion control indication.

### BRIEF DESCRIPTION OF THE DRAWINGS

The drawings illustrated herein are intended to provide a further understanding of the disclosure and form part of the disclosure. The illustrative embodiments of the disclosure and the description thereof are intended to explain the disclosure and do not constitute an unduly limitation of the disclosure. In the drawings:

FIG. 1 is a schematic diagram of an application scenario provided in an embodiment of the disclosure.

FIG. 2 is a schematic diagram of a system architecture based on a reference point presentation method provided in an embodiment of the disclosure.

FIG. 3 is a schematic diagram of a QoS model of a 5th generation (5G) network provided in an embodiment of the disclosure.

FIG. 4 is a schematic flowchart of a method for congestion control provided in the related art.

FIG. 5 is a schematic flowchart of a method for congestion control provided in an embodiment of the disclosure.

FIG. 6 is a schematic flowchart of another method for congestion control provided in an embodiment of the disclosure.

FIG. 7 is a schematic flowchart of yet another method for congestion control provided in an embodiment of the disclosure.

FIG. 8 is a schematic flowchart of still another method for congestion control provided in an embodiment of the disclosure.

FIG. 9 is a schematic flowchart of a method for congestion control provided in another embodiment of the disclosure.

FIG. 10 is a schematic diagram of a structural composition of an apparatus for congestion control provided in an embodiment of the disclosure.

FIG. 11 is a schematic diagram of a structural composition of another apparatus for congestion control provided in an embodiment of the disclosure.

FIG. 12 is a schematic diagram of a structural composition of yet another apparatus for congestion control provided in an embodiment of the disclosure.

FIG. 13 is a schematic diagram of a structural composition of still another apparatus for congestion control provided in an embodiment of the disclosure.

FIG. 14 is a schematic structural diagram of an electronic device provided in an embodiment of the disclosure.

FIG. 15 is a schematic structural diagram of a chip provided in an embodiment of the disclosure.

### DETAILED DESCRIPTION

Technical solutions in the embodiments of the disclosure will be described below in conjunction with the accompanying drawings in the embodiments of the disclosure, and apparently, the described embodiments are part but not all of the embodiments of the disclosure. All other embodiments obtained by a person of ordinary skill in the art based on the embodiments of the disclosure without paying inventive efforts shall fall within the scope of protection of the disclosure.

Technical solutions descried by the embodiments of the disclosure can be combined randomly without conflict. In the description of the disclosure, the term “multiple” means two or more, unless otherwise expressly specified.

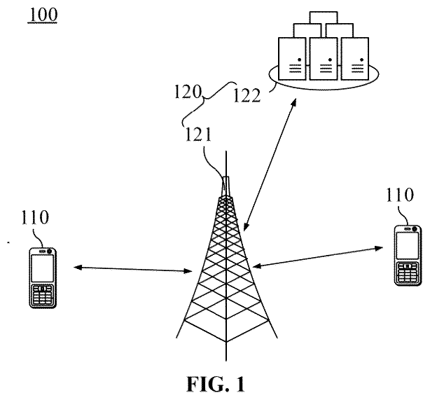

FIG. 1 is a schematic diagram of an application scenario in an embodiment of the disclosure. As shown in FIG. 1, the communication system 100 may include a terminal device 110 and a network device 120. The network device 120 may communicate with the terminal device 110 via air interface. Multi-service transmission is supported between the terminal device 110 and the network device 120.

It should be understood that the embodiments of the disclosure are only descried with the communication system 100 illustratively, but the embodiments of the disclosure are not limited thereto. That is to say, the technical solutions in the embodiments of the disclosure may be applied to various communication systems such as: a long term evolution (LTE) system, an LTE time division duplex (TDD) system, a universal mobile telecommunication system (UMTS), an Internet of things (IoT) system, a narrow band Internet of things (NB-IoT) system, an enhanced machine-type communications (eMTC) system, a 5th generation (5G) communication system (also known as a new radio (NR) communication system) or a future communication systems (e.g. 6th generation (6G) communication system or 7th generation (7G) communication system), etc.

In the communication system 100 shown in FIG. 1, the network device 120 may be an access network device that communicates with the terminal device 110. The access network device may provide communication coverage for a particular geographical area and may communicate with the terminal device 110 located within the coverage area.

The terminal device may be referred to as a user equipment (UE), a mobile station (MS), a mobile terminal (MT), a subscriber unit, a subscriber station, a mobile station, a remote station, a remote terminal, a mobile device, a user terminal, a terminal, a wireless communication device, a user agent or a user device. The terminal device may be any device that may communicate with the access network device.

The network device in the embodiments of the disclosure may include an access network device 121 and/or a core network device 122.

The access network device 121 may include one or a combination of at least two of: an evolutionary base station (an evolutionary Node B (eNB or eNodeB)) in an LTE system, a next generation radio access network (NG RAN) device, a base station in an NR system (gNB), a small station, a micro station, a wireless controller in a cloud radio access network (CRAN), a wireless-fidelity (Wi-Fi) access point, a transmission reception point (TRP), a relay station, an access point, an onboard device, a wearable device, a hub, a switch, a bridge, a router, or a network device in the future evolved public land mobile network (PLMN), etc.

The core network device 122 may be a 5G core (5GC) device, and the core network device 122 may include one or a combination of at least two of: an access and mobility management function (AMF), an authentication server function (AUSF), a user plane function (UPF), a session management function (SMF), a location management function (LMF), and a policy control function (PCF). In other embodiments, the core network device may also be an evolved packet core (EPC) device in the LTE network, for example, a session management function+core packet gateway (SMF+PGW-C) device. It should be understood that the SMF+PGW-C may achieve functions which can be achieved by SMF and PGW-C simultaneously. In the process of network evolution, the core network device 122 may also be called by other names, or a new network entity may be formed by partition of the functions of the core network, which is not limited in the embodiments of the disclosure.

The various functional units in the communication system 100 may also establish a connection via a next generation (NG) interface to realize communication. For example, the terminal device establishes an air interface connection with the access network device via an NR interface, to transmit user plane data and a control plane signaling. The terminal device may establish a control plane signaling connection with the AMF via an NG interface 1 (N1 for short). The access network device, such as a next generation radio access base station (gNB), may establish a user plane data connection with the UPF via an NG interface 3 (N3 for short). The access network device may establish a control plane signaling connection with the AMF via an NG interface 2 (N2 for short). The UPF may establish a control plane signaling connection with the SMF via an NG interface 4 (N4 for short). The UPF may interact user plane data with a data network via an NG interface 6 (N6 for short). The AMF may establish a control plane signaling connection with the SMF via an NG interface 11 (N11 for short). The SMF may establish a control plane signaling connection with the PCF via an NG Interface 7 (N7 for short).

FIG. 1 exemplarily illustrates one base station, one core network device and two terminal devices. In some embodiments, the wireless communication system 100 may include multiple base station devices and the coverage of each base station may include other numbers of terminal devices, which is not limited in the embodiments of the disclosure.

It should be noted that FIG. 1 only illustrates the system applicable to the disclosure in the form of example. Of course, the method in the embodiments of the disclosure may also be applied to other systems. In addition, the terms “system” and “network” are often used interchangeably herein. The term “and/or” herein is merely an association relationship that describes associated objects, indicating that there are three relationships, for example, A and/or B may indicate three situations: only A exist, both A and B exist, and only B exist. In addition, the character “/” herein generally indicates that the related objects are an “or” relationship. It should also be understood that the word “indicate/indicating” mentioned in the embodiments of the disclosure may be a direct indication, and it may also be an indirect indication, and it may also mean that there is an association relationship. For example, the expression that A indicates B may mean that A indicates B directly, for example, B may be obtained through A; and it may also mean that A indicates B indirectly, for example, A indicates C, and B may be obtained through C; and it may also mean that there is an association relationship between A and B. It should also be understood that the word “correspond/corresponding” in the embodiments of the disclosure may mean that there is a direct or an indirect correspondence between the related objects, and it may also mean that there is an association relationship between the related objects, and it may also be a relationship of indicating and being indicated, configuring and being configured, etc. It should also be understood that the phrases “predefined”, “agreed by protocol”, “predetermined” or “predefined rule” in the embodiments of the disclosure may be achieved by pre-storing corresponding codes, tables in a device (e.g. including the terminal device and the network device) or other means that can indicate relevant information, the specific implementations of which is not limited in the disclosure. For example, predefinition may refer to being defined in the protocol. It should also be understood that in the embodiments of the disclosure, the “protocol” may be a standard protocol in the field of communication, and may include, for example, an LTE protocol, an NR protocol, and related protocols applied in future communication systems, which is not limited in the disclosure.

To facilitate understanding of technical solutions in the embodiments of the disclosure, the related art of the embodiments of the disclosure is illustrated in the following. As an optional solution, the following related technologies may be combined with technical solutions in the embodiments of the disclosure randomly, all of which shall fall within the scope of protection of the embodiments of the disclosure.

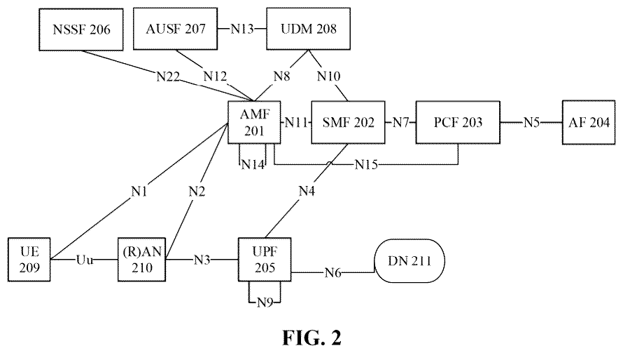

FIG. 2 is a schematic diagram of a system architecture based on a reference point presentation method provided in an embodiment of the disclosure. As shown in FIG. 2, the reference point presentation method may illustrate that there may be interactions between corresponding network function (NF) services. The network functions include, for example, an AMF 201, an SMF 202, a PCF 203, an AF 204, a UPF 205, a network slice selection function (NSSF) 206, an AUSF 207, a unified data management (UDM) 208, etc. The system may also include UE 209, a radio access network (RAN) or an access node (AN) 210, and a data network (DN) 211.

FIG. 2 illustrates the following reference points: N1 (between UE 209 and AMF 201), N2 (between RAN 210 and AMF 201), N3 (between RAN 210 and UPF 205), N4 (between SMF 202 and UPF 205), N5 (between PCF 203 and AF 204), N6 (between UPF 205 and DN 211), N7 (between SMF 202 and PCF 203), N8 (between UDM 208 and AMF 201), N9 (between two UPFs 205), N10 (between UDM 208 and SMF 202), N11 (between AMF 201 and SMF 202), N14 (between two AMFs 201), N15 (between PCF 203 and AMF 201 in a non-roaming case, or between PCF 203 and visited network and AMF 201 in a roaming case), N16 (between two SMFs; not shown), and N22 (between AMF 201 and NSSF 206).

The SMF, PCF, and AF are described below.

SMF includes establishment, modification, and release of sessions; tunnel maintenance between UPF and AN nodes; terminal Internet protocol (IP) address allocation and management; selection and control of UPF function; charging data collection and charging interface support, etc.

PCF supports a unified policy framework to manage network behavior and provides operator network control policies to other network elements and terminals.

AF may be an internal application of an operator, such as IP multimedia subsystem (IMS), or may be a third-party service, such as web services, videos or games. If the AF is an internal AF of the operator and is located in a trusted domain with other NFs, the AF directly accesses to and interacts with other NFs. If the AF is not in the trusted domain, an NEF is required to access to other NFs.

The UE performs access stratum connection with AN through Uu interface and interacts access stratum messages and performs wireless data transmission. UE performs on-access stratum (NAS) connection with the AMF through N1 interface and interacts the NAS messages. The AMF is the mobility management function in the core network, and SMF is the session management function in the core network. AMF is responsible for forwarding messages related to session management between UE and SMF in addition to mobility management for UE. PCF is the policy management function in the core network, which is responsible for formulating policies related to mobility management, session management, charging for UE and so on. UPF is a user plane function in the core network, which transmits data with the external data network via N6 interface, and transmits data with the AN via N3 interface.

The concept of quality of service (QOS) flow is introduced in the 5G network. After UE accesses to 5G network via the Uu interface, a QoS flow for data transmission is established under the control of SMF. The SMF provides the access network device with QoS flow profile information of each QoS flow, the QoS flow configuration information includes at least one of: a 5G QoS identifier (5QI), an allocation and retention priority (ARP), bit rate requirements, etc. A value of 5QI (also called 5QI or 5QI Value) is an index value that may correspond to QoS characteristics such as a time-delay and bit error rate requirement. The ARP is the priority for allocation or maintenance of resources by the access network device for QoS flows. For each QoS flow, the access network device schedules radio resources based on the QoS flow profile information received from SMF to guarantee the QoS requirement of the QoS flow.

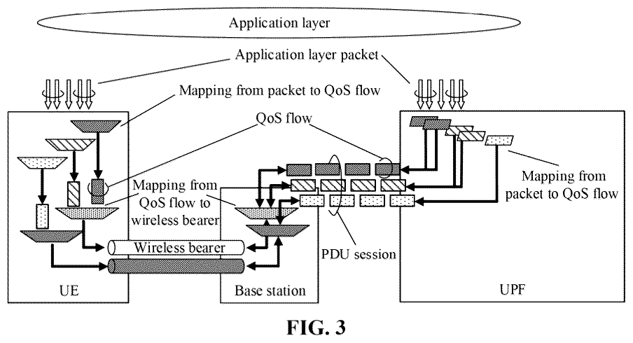

FIG. 3 is a schematic diagram of a QoS model of a 5G network provided in an embodiment of the disclosure. As shown in FIG. 3, the application layer transmits an application layer packet, and the application layer packet may be mapped to a QoS flow, thus the QoS flow is obtained. The QoS flow may be mapped to the wireless bearer, so that a service data flow may be transmitted through the wireless bearer. The QoS flow is for transmitting the service data flow, one QoS flow may be used for transmitting multiple service data flows, and one protocol data unit (PDU) session may include at most 64 QoS flows. The GPRS tunneling protocol (GTP) tunnel between 5GC and RAN is at a PDU session level. The GPRS is the abbreviation of general packet radio service and a header of a data packet transmitted in the tunnel carries a QoS flow identifier (QFI). The access network device identifies different QoS flows based on the QFI in the header of data packet, and the access network device performs the QoS flow and radio bearer mapping through a service data adaptation protocol (SDAP) layer.

Table 1 is a schematic diagram of a 5QI value of 66 provided in an embodiment of the disclosure.

TABLE 1

| 5QI value (5QI) | Time-delay | Bit error rate |
|---|---|---|
| 66 | 100 ms | 10⁻² |

As can be seen from the Table 1, in case of the 5QI value being 66, the corresponding time-delay may be 100 ms, and the corresponding bit error rate may be 10⁻².

The Internet engineering task force (IETF) defines a method for congestion control based on a user plane indication, including an explicit congestion notification (ECN) technology and a low latency, low loss, scalable throughput (L4S) technology (which is an evolved version of ECN). Both ECN and LAS indicate that there is a data congestion occurred in the transmission layer through an ECN indication bit in IP header. Then the sender and receiver of data may adapt the bit rate through application layer negotiation based on the identification of ECN indication bit, to mitigate the data congestion in the transmission layer. The support for ECN/LAS technology is considered to be introduced in 5G network, so that the congestion status of wireless network may be transmitted to the sender and receiver of data through the user plane, thereby guiding the bit rate adjustment of data.

The method considered in the 3rd generation partnership project (3GPP) is to indicate that the ECN/L4S technology needs to be enabled on a specific QoS flow through a pre-configured 5QI. The PCF allocates, based on service flow information and application information provided by the AF, a specific 5QI for the data flow on which the ECN/L4S technology needs to be enabled. The SMF binds the data flow with the 5QI to an independent QoS flow, and sends information such as a QoS flow identifier and the 5QI to the access network device. The access network device determines to enable the ECN/LAS technology on the QoS flow based on the 5QI information of the QoS flow. That is to say, the access network device identifies the QoS flow at the ECN indication bit in the IP header when the wireless network is congested.

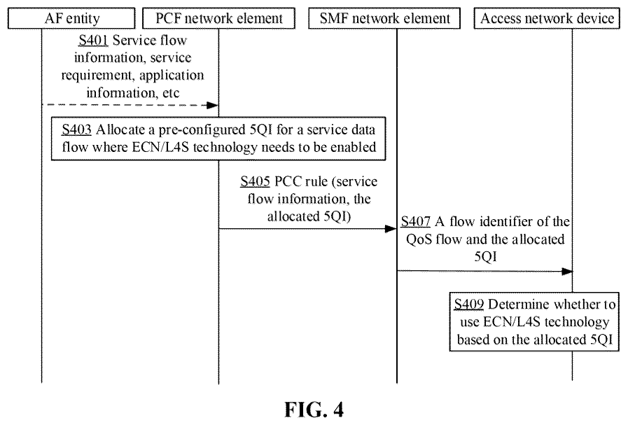

FIG. 4 is a schematic flow diagram of a method for congestion control provided in the related art. As shown in FIG. 4, the method includes the following operations.

At S401, an AF entity transmits, to a PCF network element, at least one of: service flow information, a service requirement, or application information, etc.

At S403, the PCF network element allocates a pre-configured 5QI for a service data flow on which an ECN/L4S technology needs to be enabled.

At S405, the PCF network element transmits, to an SMF network element, a PCC rule. The PCC rule includes at least one of service flow information and the allocated 5QI.

At S407, the SMF network element transmits, to an access network device, a flow identifier of the QoS flow for transmitting the service data flow and the allocated 5QI.

At S409, the access network device determines whether to use the ECN/L4S technology based on the allocated 5QI.

For example, the access network device determines to use the ECN/L4S technology when the allocated 5QI is a special 5QI, and determines not to use the ECN/L4S technology when the allocated 5QI is not a special 5QI.

In an embodiment of the disclosure, the AF entity may be understood in the same way as the AF, the PCF network element may be understood in the same way as the PCF, and the SMF network element may be understood in the same way as the SMF.

However, in the related art the system relies heavily on static configuration. For example, the AF and the PCF need to be configured consistently. In some cases, the AF may be a third-party application that does not belong to the operator, and the operator needs to negotiate with the third-party application in advance, so that the PCF needs to know in advance for which applications or which service flow information (such as service flow information within the IP range, etc.) that the ECN/L4S technology needs to be enabled. For another example, the core network device and the access network device also need to be pre-configured consistently. The PCF allocates a pre-configured 5QI for a specific service data flow based on pre-configuration. The access network device may determine whether the ECN/L4S technology is enabled for data in the corresponding QoS flow based on the allocated 5QI.

As can be seen, the related art relies heavily on static configuration. If the third-party application does not negotiate with the operator in advance, or if the core network device and the access network device are not pre-configured consistently, congestion control cannot be carried out through the user plane. In addition, even if the consistent configuration is performed in a PLMN, if UE roams from a PLMN to another PLMN, the congestion control through the user plane cannot be carried out on the roaming UE due to the fact that the configurations of different PLMNs may be different.

Embodiments of the disclosure adopt an explicit user plane congestion control indication in 5G network, thus avoiding reliance on static pre-configuration.

The method for congestion control in the embodiments of the disclosure may be applied not only to 5G network, but also to the future 3GPP network.

To facilitate understanding of technical solutions in the embodiments of the disclosure, the technical solutions of the disclosure are described in detail below by way of detailed embodiments. The above related art may be used as optional solution and combined with technical solutions in the embodiments of the disclosure randomly, all of which shall fall within the scope of protection of the embodiments of the disclosure. Embodiments of the disclosure include at least some of the following contents.

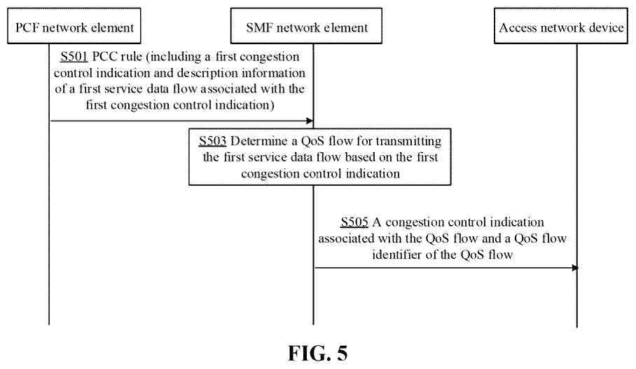

FIG. 5 is a schematic flow diagram of a method for congestion control provided in an embodiment of the disclosure. As shown in FIG. 5, the method includes the following operations.

At S501, a PCF network element sends a PCC rule to an SMF network element; the SMF network element receives the PCC rule from the PCF network element. The PCC rule includes a first congestion control indication and description information of a first service data flow associated with the first congestion control indication.

The first congestion control indication may be used for indicating to enable congestion control on the service data flow corresponding to the description information.

The PCC rule is a set of pieces of information for implementing service data flow detection and providing corresponding parameters of policy control and/or charging control. Whether a data packet belongs to a service data flow controlled by a PCC rule may be determined by matching the data packet with the description information of the service data flow in the PCC rule. A PCC rule may be represented by using the following Charging-Rule-Definition AVP (it should be noted that only some parameters are listed below, where the item in the symbol [ ] is optional and the symbol * indicates that the related item may be multiple):

Charging-Rule-Definition:: = < AVP Header: 1003 > //definition
of charging rule

| | |
|---|---|
| {Charging-Rule-Name} | //name of charging rule |
| [Service-Identifier] | //service identifier |
| [Rating-Group] | //rating group |
| * [Flow-Description] | //description of service data flow |
| [QoS-Information] | //QoS information |

The Flow-Description may include at least one of: a source IP address of the service data flow, a destination IP address of the service data flow, a source port of the service data flow, a destination port of the service data flow, a protocol number, a source MAC address of the service data flow, a destination MAC address of the service data flow, and so on. QoS-Information is a QoS authorized by the PCC rule.

The congestion control indication in the embodiments of the disclosure (including: a first congestion control indication, or the following congestion control indication associated with the QoS flow, a congestion control indication associated with a first QoS flow, a congestion control indication associated with a second QoS flow) may include a user plane congestion control indication. The user plane congestion control indication may be used for indicating to perform congestion control on user plane data, for example, the first congestion control indication may indicate to enable the congestion control on the first service data flow. In case that the congestion control is enabled on the first service data flow, if congestion occurs in a process of transmission of the first service data flow, the bit rate is adjusted, to mitigate the congestion of the first service data flow in the transmission process.

The PCC rule may be set by a PCF network element, and the PCC rule is at a service data flow-level. In an embodiment of the disclosure, the PCC rule includes at least a first congestion control indication and description information of a first service data flow associated with the first congestion control indication. In some embodiments, the description information of the first service data flow may also be referred to as a description of the first service data flow, an identifier of the first service data flow, identifier information of the first service data flow, or a characteristic of the first service data flow in other embodiments.

In some embodiments, different PCC rules may include description information of different service data flows. For example, a PCC rule includes a first congestion control indication and description information of a first service data flow corresponding to the first congestion control indication. Another PCC rule may include a second congestion control indication and description information of a second service data flow corresponding to the second congestion control indication. Yet another PCC rule includes description information of a third service data flow (the description information of the third service data flow has no associated congestion control indication). In other embodiments, one PCC rule may include description information of different service data flows, and description information of each service data flow may or may not be associated with a congestion control indication.

At S503, the SMF network element determines a QoS flow for transmitting the first service data flow based on the first congestion control indication.

In some embodiments, if the first congestion control indication is different from the second congestion control indication, then the determined QoS flow for transmitting the first service data flow is different from the QoS flow for transmitting the second service data flow. In some embodiments, if the first congestion control indication is associated with the first service data flow and the third service data flow is not associated with a congestion control indication, the QoS flow for transmitting the first service data flow is different from the QoS flow for transmitting the third service data flow.

The operation of determining the QoS flow for transmitting the first service data flow may include determining the QoS flow for transmitting the first service data flow corresponding to the description information. In some embodiments, the SMF network element may determine the QoS flow for transmitting the first service data flow based on the description information of the first service data flow.

At S505, the SMF network element sends a congestion control indication associated with the QoS flow and a QoS flow identifier of the QoS flow to an access network device.

The congestion control indication associated with the QoS flow may be understood in the same way as a congestion control indication configured for the QoS flow.

In some embodiments, the congestion control indication associated with the QoS flow for transmitting the first service data flow may be the same as the first congestion control indication. For example, when the first congestion control indication is the first type of congestion control indication, the congestion control indication associated with the QoS flow is also the first type of congestion control indication. When the first congestion control indication is a second type of congestion control indication, the congestion control indication associated with the QoS flow is also the second type of congestion control indication.

In some embodiments, the SMF network element may send the QoS flow profile to the access network device, and the QoS flow profile may include a QoS parameter (or referred to as a QoS flow requirement) of the QoS flow. The QoS parameter includes information such as 5QI, ARP, bit rate requirement.

In some embodiments, the QoS flow profile (QOS profile) may be associated with and/or may correspond to the congestion control indication associated with the QoS flow and/or the QoS flow identifier. In other embodiments, the QoS flow profile may include the congestion control indication associated with the QoS flow and/or the QoS flow identifier, for example, the QoS flow profile may include the QoS parameter and the congestion control indication associated with the QoS flow and/or the QoS flow identifier. The QoS flow identifier is configured to identify the QoS flow.

The access network device may map the QoS flow to an appropriate wireless bearer based on the QoS parameter, to perform corresponding wireless side resource configuration.

In some embodiments, the SMF network element may sends a congestion control indication associated with the QoS flow and a QoS flow identifier of the QoS flow to an access network device through an AMF network element.

In the embodiment of the disclosure, an SMF network element receives a PCC rule from a PCF network element, the PCC rule includes a first congestion control indication and description information of a first service data flow associated with the first congestion control indication; the SMF network element determines a QoS flow for transmitting the first service data flow based on the first congestion control indication; and the SMF network element sends a congestion control indication associated with the QoS flow and a QoS flow identifier of the QoS flow to an access network device. In this way, the congestion control indication associated with the QoS flow is sent by the SMF network element to access network device, to enable the access network device to perform congestion control on the QoS flow which is associated with the congestion control indication. Therefore, effective congestion control can be provided since the QoS flow on which the congestion control is performed by the access network device is indicated by the SMF network element.

In some embodiments, the QoS flow for transmitting the first service data flow is an existing first QoS flow, the congestion control indication associated with the first QoS flow is the same as the first congestion control indication.

The existing first QoS flow may be a first QoS flow which has been created by the SMF network element. The existing first QoS flow may be included in existing one or more QoS flows.

In case that the first QoS flow is created or newly created by the SMF network element, the SMF network element may configure a congestion control indication for the first QoS flow, so that the first QoS flow may be associated with the congestion control indication.

The first congestion control indication and the congestion control indication associated with the first QoS flow are both ECNs. Alternatively, the first congestion control indication and the congestion control indication associated with the first QoS flow are both L4Ss.

In other embodiments, the QoS flow for transmitting the first service data flow is a second QoS flow newly created by the SMF network element, and the congestion control indication associated with the second QoS flow is the same as the first congestion control indication.

In case that the second QoS flow is newly created by the SMF network element, the SMF network element may configure a congestion control indication for the second QoS flow, so that the second QoS flow may be associated with the congestion control indication.

The first congestion control indication and the congestion control indication associated with the second QoS flow are both ECNs. Alternatively, the first congestion control indication and the congestion control indication associated with the second QoS flow are both L4Ss.

It should be noted that in the embodiments of the disclosure, the first congestion control indication corresponds to the description information of the first service data flow, and the congestion control indication associated with the first QoS flow and/or the congestion control indication associated with the second QoS flow corresponds to the QoS flow.

In some embodiments, when the first congestion control indication is different from all congestion control indications associated with existing one or more QoS flows, the QoS flow for transmitting the first service data flow is a second QoS flow newly created by the SMF network element.

In other embodiments, when each of existing one or more QoS flows is not associated with a congestion control indication, the QoS flow for transmitting the first service data flow is a second QoS flow newly created by the SMF network element.

The existing one or more QoS flows may be all existing QoS flows. For example, in case that all the congestion control indications associated with the existing one or more QoS flow are ECNs and the first congestion control indication is LAS, or in case that all the congestion control indications associated with the existing one or more QoS flow are L4Ss and the first congestion control indication is ECN, the QoS flow for transmitting the first service data flow is a second QoS flow newly created by the SMF network element.

In some embodiments, the PCC rule further includes a QoS requirement of the first service data flow.

The operation that SMF network element determines the QoS flow for transmitting the first service data flow based on the first congestion control indication includes the following action.

The SMF network element determines the QoS flow for transmitting the first service data flow based on the QoS requirement of the first service data flow and the first congestion control indication.

Illustratively, the QoS flows for transmitting different service data flows are different when the QoS requirements of the different service data flows are different. The QoS flows for transmitting different service data flows are different when the congestion control indications associated with the description information of the different service data flows are different.

In some embodiments, the QoS flow for transmitting the first service data flow is the existing first QoS flow, the congestion control indication associated with the first QoS flow is the same as the first congestion control indication, and the QoS flow requirement corresponding to the first QoS flow is the same as the QoS requirement of the first service data flow.

In other embodiments, the QoS flow for transmitting the first service data flow is the second QoS flow newly created by the SMF network element, the congestion control indication associated with the second QoS flow is the same as the first congestion control indication, and the QoS flow requirement corresponding to the second QoS flow is the same as the QoS requirement of the first service data flow.

The case that a QoS flow for transmitting the first service data flow is a second QoS flow newly created by the SMF network element is illustrated below.

In case that the QoS requirement of the first service data flow is different from all the QoS flow requirements corresponding to the existing one or more QoS flows, the QoS flow for transmitting the first service data flow is the second QoS flow newly created by the SMF network element.

In case that the QoS requirement of the first service data flow is the same as at least one of the QoS flow requirements corresponding to the existing one or more QoS flows, but the congestion control indication associated with the at least one QoS flow is different from the first congestion control indication, the QoS flow for transmitting the first service data flow is the second QoS flow newly created by the SMF network element.

In case that at least one of the congestion control indications associated with the existing one or more QoS flows is the same as the first congestion control indication, but the QoS flow requirement of the QoS flow associated with the at least one congestion control indication is different from the QoS requirement of the first service data flow, the QoS flow for transmitting the first service data flow is the second QoS flow newly created by the SMF network element.

In some embodiments, the QoS requirement includes at least one of the following items:

a 5G QoS identifier (5QI value), an allocation priority, a bit rate requirement, a time-delay requirement for transmission, or a bit error rate requirement for transmission.

The QoS requirement may also be referred to as a QoS parameter in other embodiments. The QoS requirement may also include a bandwidth requirement.

The QoS requirements are different when the 5G QoS identifiers are different. The QoS requirements are different when the allocation priorities are different. The QoS requirements are different when the bit rate requirements are different. The QoS requirements are different when the time-delay requirements for transmission are different. The QoS requirements are different when the bit error rate requirements for transmission are different.

In some embodiments, the description information includes at least one of: packet header information, an application identifier, or a service identifier.

The packet header information includes at least one of: a source IP address, a destination IP address, a source port, a destination port, a source MAC address, or a destination MAC address.

The application identifier may be an application identifier corresponding to the first service data flow. The application identifier may include an identifier of an application program or application software. For example, the application identifier may include an identifier of Tencent Video, an identifier of iQiyi Video or an identifier of WeChat, etc. The application identifier may be an internal application identifier of the operator or an application identifier of a third-party application.

The service identifier may be a service identifier corresponding to the first service data flow. Different services identifiers may correspond to different services of the first service data flow, respectively. For example, the service identifier may include: an identifier of voice communication service, an identifier of video playback service, an identifier of video communication service, and an identifier of web browsing service, etc. The service identifier may be an internal service identifier of the operator or a service identifier of a third-party service.

The packet header information may also include protocol types above the IP layer.

In some embodiments, the first congestion control indication includes an ECN or an L4S.

Embodiments of the disclosure are not limited thereto, and the first congestion control indication may also include instructions specified in other protocols.

In some embodiments, the QoS requirement of the first service data flow is determined based on the service requirement of the first service data flow.

In some embodiments, the service requirement includes at least one of: a service type, a bit rate requirement for service, a time-delay requirement for transmission, a priority requirement for transmission, or a bit error rate requirement for transmission.

In some embodiments, the first congestion control indication and the description information of the first service data flow associated with the first congestion control indication included in the PCC rule sent by the PCF network element to the SMF network element may be sent from the AF entity.

In some embodiments, the service requirement of the first service data flow may be sent by the AF entity.

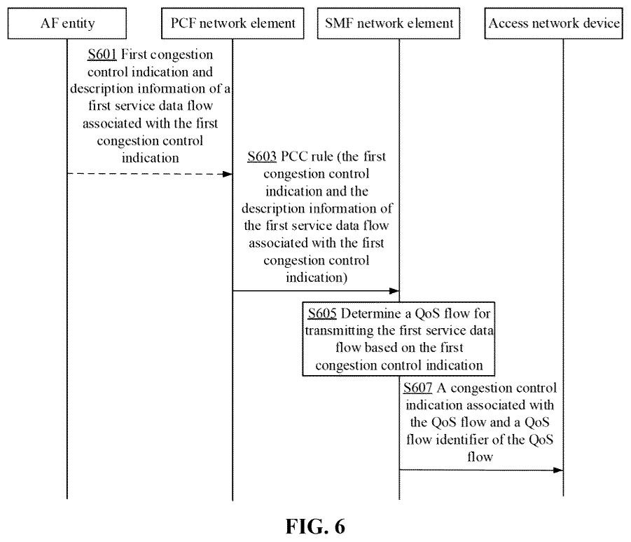

FIG. 6 is a schematic flow diagram of another method for congestion control provided in an embodiment of the disclosure. As shown in FIG. 6, the method includes the following operations.

At S601, an AF entity sends a first congestion control indication and description information of a first service data flow associated with the first congestion control indication to a PCF network element. The PCF network element receives the first congestion control indication and the description information of the first service data flow associated with the first congestion control indication from the AF entity.

In some embodiments, the first congestion control indication and the description information of the first service data flow are configured for the PCF to send the PCC rule to the SMF network element. The PCC rule includes the first congestion control indication and the description information of the first service data flow associated with the first congestion control indication.

At S603, the PCF network element sends the PCC rule to an SMF network element, and the SMF network element receives the PCC rule from the PCF network element. The PCC rule includes the first congestion control indication and the description information of the first service data flow associated with the first congestion control indication.

At S605, the SMF network element determines a QoS flow for transmitting the first service data flow based on the first congestion control indication.

At S607, the SMF network element sends a congestion control indication associated with the QoS flow and a QoS flow identifier of the QoS flow to an access network device.

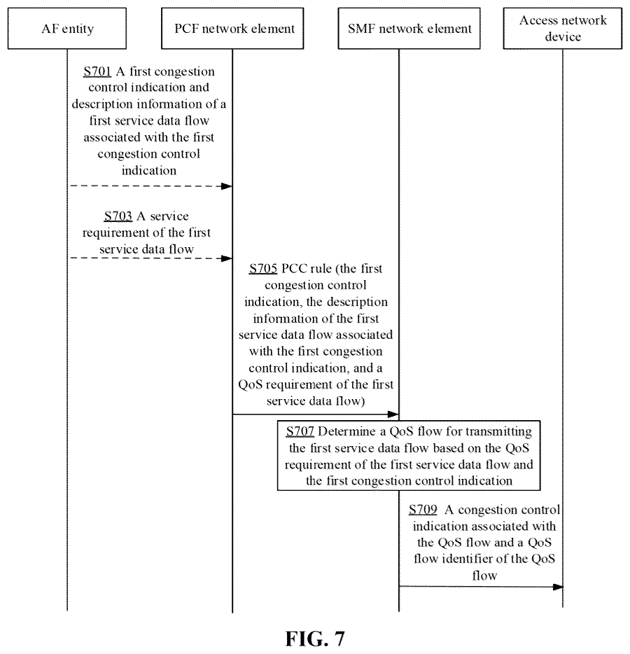

FIG. 7 is a schematic flow diagram of yet another method for congestion control provided in an embodiment of the disclosure. As shown in FIG. 7, the method includes the following operations.

At S701, an AF entity sends a first congestion control indication and description information of a first service data flow associated with the first congestion control indication to a PCF network element; and the PCF network element receives the first congestion control indication and the description information of the first service data flow associated with the first congestion control indication from the AF entity.

At S703, the AF entity sends a service requirement of the first service data flow to the PCF network element; and the PCF network element receives the service requirement of the first service data flow from the AF entity.

The first congestion control indication, the description information of the first service data flow associated with the first congestion control indication, and the service requirement of the first service data flow may be transmit in one signaling.

At S705, the PCF network element sends the PCC rule to an SMF network element; and the SMF network element receives the PCC rule from the PCF network element. The PCC rule includes: the first congestion control indication, the description information of the first service data flow associated with the first congestion control indication, and a QoS requirement of the first service data flow. The QoS requirement of the first service data flow is determined based on the service requirement of the first service data flow.

At S707, the SMF network element determines a QoS flow for transmitting the first service data flow based on the QoS requirement of the first service data flow and the first congestion control indication.

At S709, the SMF network element sends a congestion control indication associated with the QoS flow and a QoS flow identifier of the QoS flow to an access network device.

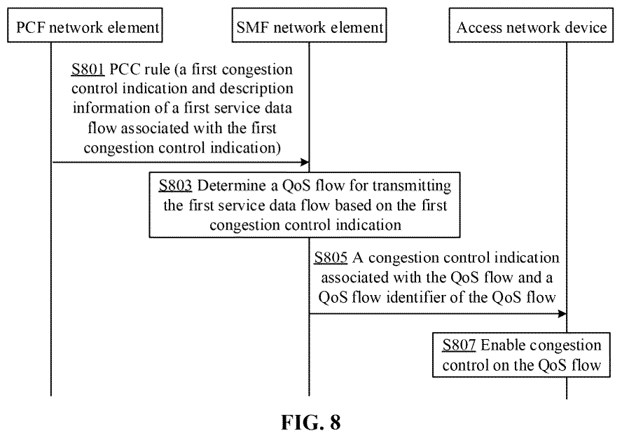

FIG. 8 is a schematic flow diagram of still another method for congestion control provided in an embodiment of the disclosure. As shown in FIG. 8, the method includes the following operations.

At S801, a PCF network element sends a PCC rule to an SMF network element; and the SMF network element receives the PCC rule from the PCF network element. The PCC rule includes a first congestion control indication and description information of a first service data flow associated with the first congestion control indication.

At S803, the SMF network element determines a QoS flow for transmitting the first service data flow based on the first congestion control indication.

At S805, the SMF network element sends a congestion control indication associated with the QoS flow and a QoS flow identifier of the QoS flow to an access network device. The access network device receives the congestion control indication associated with the QoS flow and the QoS flow identifier of the QoS flow from the SMF network element.

At S807, the access network device enables congestion control on the QoS flow.

Accordingly, the QoS flow on which the congestion control is enabled may be associated with a congestion control indication, and the QoS flow on which the congestion control is enabled may correspond to a flow identifier. The congestion control indication associated with the QoS flow may be associated with the QoS flow identifier, so that the access network device may enable the congestion control on the QoS flow corresponding to the QoS flow identifier associated with a congestion control identifier.

The access network device receives data packets from a GTP tunnel at a PDU session level from an UPF, distinguishes different QoS flows based on a QFI (a QoS flow identifier) carried in the header of data packet, and sends the data packet to the UE through the corresponding wireless bearer.

In case that the access network device enables the congestion control on the QoS flow, when the access network device determines, based on a QFI carried in a header of a data packet, that the QFI is included in a QoS flow identifier that may be associated with a congestion control indication and data carrying the QFI in the header of the data packet is congested, the access network device performs the congestion control on the data carrying the QFI in the header of the data packet. For example, a bit rate of data carrying the QFI in the header of data packet may be adjusted. Illustratively, if the data carrying the QFI in the header of data packet is video data and the video is congested, the access network device may adjust definition of the video.

In some embodiments, the congestion control indication associated with the QoS flow includes an ECN or an LAS.

In some embodiments, the operation that the access network device enables the congestion control on the QoS flow includes the action that the access network device enables ECN congestion control on the QoS flow associated with the ECN.

In other embodiments, the operation that the access network device enables the congestion control on the QoS flow includes the action that the access network device enables L4S congestion control on the QoS flow associated with the LAS.

In this way, different ways of congestion controls may be enabled on the QoS flow through different congestion control indications.

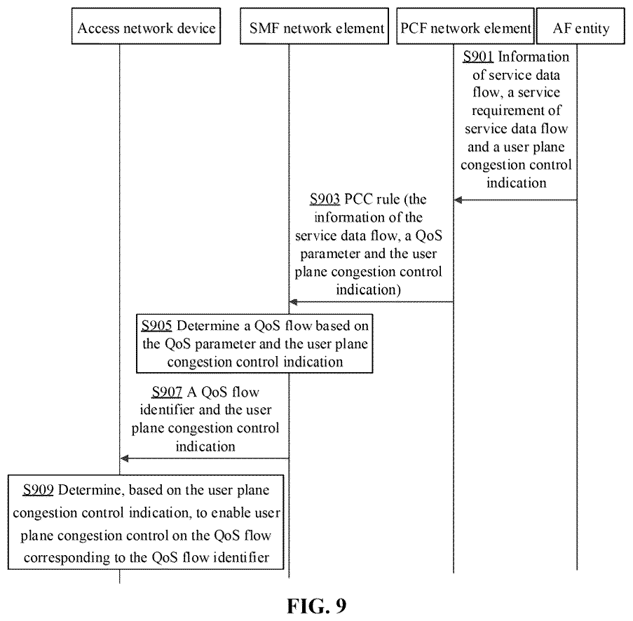

FIG. 9 is a schematic flow diagram of a method for congestion control provided in another embodiment of the disclosure. As shown in FIG. 9, the method includes the following operations.

At S901, an AF entity sends information of a service data flow, a service requirement of the service data flow and a user plane congestion control indication to a PCF network element.

In this embodiment, before sending service data, the AF entity provides, to a PCF network element located in the core network through a control plane signaling, the information of the service data flow (corresponding to the description information of the first service data flow described above), the service requirement of the service data flow (corresponding to the service requirement of the first service data flow described above), and the user plane congestion control indication (corresponding to the first congestion control indication described above).

The information of the service data flow may be a characteristic of the header of user plane data corresponding to the service data flow. For example, for the IP type of data, the information of the service data flow may include at least one of: an IP source address, a destination IP address, a source port number, or a destination port number, etc. For Ethernet type of data, the information of the service data flow may include at least one of: a source MAC address, or a destination MAC address, etc.

The service requirement of the service data flow may include, for example, at least one of: a service type, a bit rate requirement for service, a time-delay requirement for transmission, a priority requirement for transmission, or a bit error rate requirement for transmission, etc.

The user plane congestion control indication includes, for example, an ECN indication or an LAS indication, etc.

At S903, the PCF network element sends a PCC rule to an SMF network element. The PCC rule includes: the information of the service data flow, a QoS parameter and the user plane congestion control indication.

The QoS parameter (which may be the QoS requirement described above) may be determined based on the service requirement of the service data flow.

The PCF network element determines the PCC rule for the service data flow based on the information obtained from the AF entity. The PCC rules may include: the information of the service data flow, the user plane congestion control indication, the QoS requirement of the service data flow (such as a 5OI, an allocation priority, a bit rate requirement, a time-delay requirement for transmission, or a bit error rate requirement for transmission, etc).

At S905, the SMF network element determines a QoS flow based on the QoS parameter and the user plane congestion control indication.

The SMF network element may determine the QoS flow for the service data flow based on the user plane congestion control indication and the QoS parameter of the service data flow.

For example, for two service data flows with a same QoS requirement, if the user plane congestion control needs to be enabled on the two service data flows, the two service data flows may be bound to a same QoS flow for transmission. For another example, if the user plane congestion control needs to be enabled on one of the two service data flows with a same QoS requirement, and the user plane congestion control does not need to be enabled on the other one service data flow, the two service data flows may be transmitted with different QoS flows. For another example, if the user plane congestion control needs to be enabled on both two service data flows with different QoS requirements, the two service data flows may also be transmitted with different QoS flows. In addition, considering that the user plane congestion control may also include different ways such as ECN and LAS congestion controls, for two service data flows with a same QoS requirement yet the user plane congestion control with the ECN mode needs to be enabled on one of the two service data flows and the user plane congestion control with the LAS mode needs to be enabled on the other one, two service data flows may also be transmitted with different QoS flows.

At S907, the SMF network element sends a QoS flow identifier and the user plane congestion control indication to an access network device.

The SMF network element sends the QoS flow identifier and the user plane congestion control indication to the access network device.

At S909, the access network device determines, based on the user plane congestion control indication, to enable user plane congestion control on the QoS flow corresponding to the QoS flow identifier.

The access network device may determine whether to enable the user plane congestion control on the QoS flow based on the user plane congestion control indication. In case that the user plane congestion control is enabled, a user plane congestion control way such as ECN or LAS to be enabled may also be determined.

In the embodiments of the disclosure, an explicit user plane congestion control indication is adopted in the 5G network, thus dependence on static pre-configuration can be avoided. According to the embodiments of the disclosure, the third-party application may indicate through dynamic signaling that on which service data the user plane congestion control is enabled, without reserving information such as an address port for the user plane congestion control by the PCF network element. For example, the PCF network element does not need to pre-configure address information (such as at least one of an IP address, port or MAC address) corresponding to information of service flow and/or application information provided by the AF, thus support of new service applications by the network can be enhanced. The network side (such as the PCF network element) does not need to reserve 5QI information for the user plane congestion control, thus network resilience can be enhanced. In addition, because the user plane congestion control is indicated by the AF entity, the problem that the user plane congestion control cannot be supported when the UE roaming between different networks can be avoided.

The preferred embodiments of the disclosure are described in detail above in conjunction with the accompanying drawings, but the disclosure is not limited to the specific details in the above embodiments. Multiple simple variations can be made to technical solutions of the disclosure within the technical concept of the disclosure, all of which fall within the scope of protection of the disclosure. For example, the specific technical features described in the above mentioned specific embodiments can be combined in any suitable way without contradiction. The disclosure will not explain the various possible combinations separately in order to avoid unnecessary repetition. For another example, the various different embodiments of the disclosure can be combined randomly, so long as they do not contradict the idea of the disclosure, such combinations should also be regarded as the contents disclosed by the disclosure. For another example, on the premise of no conflict, the various embodiments and/or the technical features in the various embodiments described in the disclosure can be combined with the related art randomly, and the technical solutions obtained by combination shall also fall within the scope of protection of the disclosure.

It should also be understood that in various method embodiments of the disclosure, the size of the serial numbers in the above-mentioned processes does not mean the execution sequence, but the execution sequence of each process should be determined by its function and inherent logic, and should not constitute any limitation on the implementation process of embodiments of the disclosure. In addition, in the embodiments of the disclosure, the terms “downlink”, “uplink” and “sidelink” are used for indicating the transmission direction of signal or data, where the term “downlink” is used for indicating that the transmission direction of the signal or data is a first direction from a site to user equipment of a cell; the term “uplink” is used for indicating that the transmission direction of the signal or data is a second direction from the user equipment of the cell to the site, and the term “sidelink” is used for indicating that the transmission direction of the signal or data is a third direction from first user equipment to second user equipment. For example, the “downlink signal” indicates that the transmission direction of the signal is the first direction. In addition, in the embodiments of the disclosure, the term “and/or” is merely an association relationship that describes associated objects, indicating that there are three relationships. Specifically, A and/or B may indicate three situations that: only A exists, both A and B exist, and only of B exists. In addition, the character “/” generally indicates that the related objects are an “or” relationship herein.

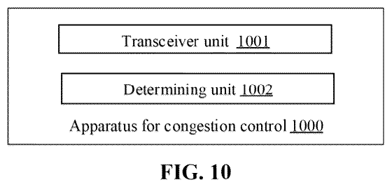

FIG. 10 is a schematic diagram of a structural composition of an apparatus for congestion control provided in an embodiment of the disclosure, which is applied to a SMF network element. As shown in FIG. 10, the apparatus for congestion control 1000 includes a transceiver unit 1001 and a determining unit 1002.

The transceiver unit is configured to receive a PCC rule from a PCF network element. The PCC rule includes a first congestion control indication and description information of a first service data flow associated with the first congestion control indication.

The determining unit is configured to determine a QoS flow for transmitting the first service data flow based on the first congestion control indication.

The transceiver unit 1001 is further configured to send a congestion control indication associated with the QoS flow and a QoS flow identifier of the QoS flow to an access network device.

In some embodiments, the QoS flow for transmitting the first service data flow is an existing first QoS flow, the congestion control indication associated with the first QoS flow is the same as the first congestion control indication.

Alternatively, the QoS flow for transmitting the first service data flow is a second QoS flow newly created by the SMF network element, and the congestion control indication associated with the second QoS flow is the same as the first congestion control indication.

In some embodiments, when the first congestion control indication is different from all congestion control indications associated with existing one or more QoS flows, the QoS flow for transmitting the first service data flow is a second QoS flow newly created by the SMF network element.

Alternatively, when each of existing one or more QoS flows is not associated with a congestion control indication, the QoS flow for transmitting the first service data flow is a second QoS flow newly created by the SMF network element.

In some embodiments, the PCC rule further includes: a QoS requirement of the first service data flow. The determining unit 1002 is further configured to determine the QoS flow for transmitting the first service data flow based on the QoS requirement of the first service data flow and the first congestion control indication.

In some embodiments, the QoS flow for transmitting the first service data flow is an existing first QoS flow; the congestion control indication associated with the first QoS flow is the same as the first congestion control indication, and a QoS flow requirement corresponding to the first QoS flow is the same as the QoS requirement of the first service data flow.

Alternatively, the QoS flow for transmitting the first service data flow is a second QoS flow newly created by the SMF network element, the congestion control indication associated with the second QoS flow is the same as the first congestion control indication, and a QoS flow requirement corresponding to the second QoS flow is the same as the QoS requirement of the first service data flow.

In some embodiments, the QoS requirement includes at least one of: a 5G QoS identifier, an allocation priority, a bit rate requirement, a time-delay requirement for transmission, or a bit error rate requirement for transmission.

In some embodiments, the description information includes at least one of: packet header information, an application identifier, or a service identifier.

The packet header information includes at least one of: a source IP address, a destination IP address, a source port, a destination port, a source MAC address, or a destination MAC address.

In some embodiments, the first congestion control indication includes an ECN or an L4S.

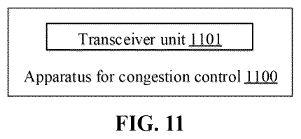

FIG. 11 is a schematic diagram of a structural composition of another apparatus for congestion control provided in an embodiment of the disclosure, which is applied to a PCF network element. As shown in FIG. 11, the apparatus for congestion control 1100 includes a transceiver unit 1101.

The transceiver unit is configured to send a PCC rule to an SMF network element. The PCC rule includes a first congestion control indication and description information of a first service data flow associated with the first congestion control indication.

In some embodiments, the apparatus for congestion control 1100 may further include a determining unit for determining the PCC rule.

In some embodiments, the description information includes at least one of: packet header information, an application identifier, or a service identifier.

The packet header information includes at least one of: a source IP address, a destination IP address, a source port, a destination port, a source MAC address, or a destination MAC address.

In some embodiments, the PCC rule further includes: a QoS requirement of the first service data flow. The QoS requirement of the first service data flow is determined based on a service requirement of the first service data flow.

In some embodiments, the QoS requirement includes at least one of: a 5G QoS identifier, an allocation priority, a bit rate requirement, a time-delay requirement for transmission, or a bit error rate requirement for transmission.

In some embodiments, the transceiver unit 1101 is further configured to: receive the first congestion control indication and the description information of the first service data flow associated with the first congestion control indication from an AF entity; and/or receive a service requirement of the first service data flow from the AF entity.

In some embodiments, the service requirement includes at least one of: a service type, a bit rate requirement for service, a time-delay requirement for transmission, a priority requirement for transmission, or a bit error rate requirement for transmission.

In some embodiments, the first congestion control indication includes an ECN or an L4S.

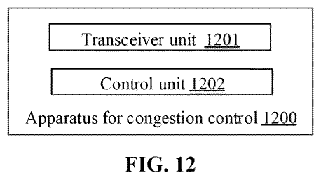

FIG. 12 is a schematic diagram of the structural composition of yet another apparatus for congestion control provided in an embodiment of the disclosure, which is applied to an access network device. As shown in FIG. 12, the apparatus for congestion control 1200 includes a transceiver unit 1201 and a control unit 1202.

The transceiver unit is configured to receive a congestion control indication associated with a QoS flow and a QoS flow identifier of the QoS flow from an SMF network element.

The control unit is configured to enable congestion control on the QoS flow.

In some embodiments, the congestion control indication associated with the QoS flow includes an ECN or an LAS. The control unit 1202 is further configured to perform the following operations.

ECN congestion control on the QoS flow associated with the ECN is enabled.

Alternatively, L4S congestion control on the QoS flow associated with the L4S is enabled.

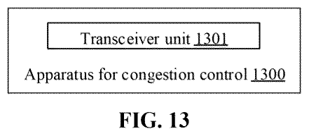

FIG. 13 is a schematic diagram of a structural composition of still another apparatus for congestion control provided in an embodiment of the disclosure, which is applied to an access network device. As shown in FIG. 13, the apparatus for congestion control 1300 includes a transceiver unit 1301.

The transceiver unit is configured to send a first congestion control indication and description information of a first service data flow associated with the first congestion control indication to a PCF network element.

In some embodiments, the apparatus for congestion control 1300 further includes a determining unit configured to determine the first congestion control indication and the description information of the first service data flow associated with the first congestion control indication.

In some embodiments, the description information includes at least one of: packet header information, an application identifier, or a service identifier.

The packet header information includes at least one of: a source IP address, a destination IP address, a source port, a destination port, a source MA) address, or a destination MAC address.

In some embodiments, the transceiver unit 1301 is further configured to send a service requirement of the first service data flow to the PCF network element.

In some embodiments, the service requirement includes at least one of: a service type, a bit rate requirement for service, a time-delay requirement for transmission, a priority requirement for transmission, or a bit error rate requirement for transmission.

In some embodiments, the first congestion control indication includes an ECN or an L4S.

It will be understood by those skilled in the art that the above mentioned apparatus for congestion control in embodiments of the disclosure may be understood with reference to the related description of the method for congestion control in embodiments of the disclosure.

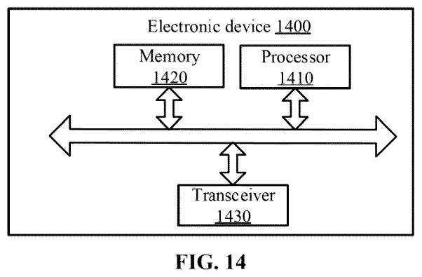

FIG. 14 is a schematic structural diagram of an electronic device provided in an embodiment of the disclosure. The electronic device 1400 may include one of: an SMF network element, a PCF network element, an access network device, or an AF entity. The electronic device 1400 illustrated in FIG. 14 includes a processor 1410 and a memory 1420. The memory 1420 stores a computer program executable by the processor 1410. The processor 1410 is configured to perform the method for congestion control of any one of the above mentioned embodiments when executing the program.

The electronic device 1400 includes a processor 1410. The processor 1410 may invoke a computer program from a memory and run the computer program to perform the method in the embodiments of the disclosure.

In some embodiments, as shown in FIG. 14, the electronic device 1400 may also include a memory 1420. The processor 1410 may invoke a computer program from the memory 1420 and run the computer program to perform the method in the embodiments of the disclosure.

The memory 1420 may be a separate device independent of the processor 1410, or may be integrated within the processor 1410.

In some embodiments, as shown in FIG. 14, the electronic device 1400 may also include a transceiver 1430. The processor 1410 may control the transceiver 1430 to communicate with other devices, and in particular, to send information or data to other devices or receive information or data from other devices.

The transceiver 1430 may include a transmitter and a receiver. The transceiver 1430 may further include an antenna, and there may be one or more antennas.

In some embodiments, the electronic device 1400 may be specifically the network device in the embodiments of the disclosure. The electronic device 1400 may implement the corresponding processes implemented by the network device in the various methods in embodiments of the disclosure, which is not elaborated herein again for the sake of simplicity.

In some embodiments, the electronic device 1400 may be the mobile terminal/terminal device in the embodiments of the disclosure specifically. The electronic device 1400 may implement the corresponding processes implemented by the mobile terminal/terminal device in the various methods in embodiments of the disclosure, which is not elaborated herein again for the sake of simplicity.

A computer storage medium is also provided in an embodiment of the disclosure. The computer storage medium stores one or more programs that are executable by one or more processors to perform the method for congestion control in any one of the embodiments of the disclosure.

In some embodiments, the computer-readable storage medium may be applied to the SMF network element, the PCF network element, the access network device, or the AF entity in embodiments of the disclosure. The computer program causes a computer to perform the corresponding processes implemented by the network device in the various methods in embodiments of the disclosure, which is not elaborated herein again for the sake of simplicity.

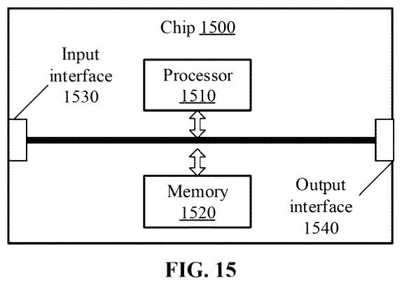

FIG. 15 is a schematic structural diagram of a chip provided in an embodiment of the disclosure. The chip 1500 shown in FIG. 15 includes a processor 1510. The processor 1510 may invoke a computer program from a memory and run the computer program to perform the method in the embodiments of the disclosure.

In some embodiments, as shown in FIG. 15, the chip 1500 may also include a memory 1520. The processor 1510 may invoke a computer program from the memory 1520 and run the computer program to perform the method in the embodiments of the disclosure.

The memory 1520 may be a separate device independent of the processor 1510, or may be integrated within the processor 1510.

In some embodiments, the chip 1500 may also include an input interface 1530. The processor 1510 may control the input interface 1530 to communicate with other devices or chips, and in particular, to obtain information or data from other devices or chips.

In some embodiments, the chip 1500 may also include an output interface 1540. The processor 1510 may control the output interface 1540 to communicate with other devices or chips, and in particular, to output information or data to other devices or chips.

In some embodiments, the chip may be applied to the network device in embodiments of the disclosure, and the chip may implement the corresponding processes implemented by the network device in the various methods in embodiments of the disclosure, which is not elaborated herein again for the sake of simplicity.

In some embodiments, the chip may be applied to the mobile terminal/terminal device in the embodiments of the disclosure, and the chip may implement the corresponding processes implemented by the mobile terminal/terminal device in the various methods in embodiments of the disclosure, for the sake of simplicity, which is not elaborated herein again.

It should be understood that the chip mentioned in embodiments of the disclosure may also be referred to as a system on a chip, a system chip, a chip system, or a system chip on a chip.

A computer program product is also provided in an embodiment of the disclosure. The computer program product includes a computer storage medium storing a computer program. The computer program includes instructions executable by at least one processor that, when being executed by the at least one processor, cause the at least one processor to perform the method for congestion control of any one of the embodiments of the disclosure.

In some embodiments, the computer program product may be applied to the SMF network element, the PCF network element, the access network device, or the AF entity in embodiments of the disclosure. The computer program causes a computer to perform the corresponding processes implemented by the network device in the various methods in embodiments of the disclosure, which is not elaborated herein again for the sake of simplicity.

A computer program is also provided in an embodiment of the disclosure. The computer program causes a computer to perform the method for congestion control of any one of the embodiments of the disclosure.

In some embodiments, the computer program may be applied to the SMF network element, the PCF network element, the access network device, or the AF entity in embodiments of the disclosure. The computer program, when being run on a computer, causes the computer to perform the corresponding processes implemented by the network device in the various methods in embodiments of the disclosure, which is not elaborated herein again for the sake of simplicity.

In the embodiments of the disclosure, an SMF network element receives a PCC rule from a PCF network element, the PCC rule includes a first congestion control indication and description information of a first service data flow associated with the first congestion control indication; the SMF network element determines a QoS flow for transmitting the first service data flow based on the first congestion control indication; and the SMF network element sends a congestion control indication associated with the QoS flow and a QoS flow identifier of the QoS flow to an access network device. In this way, the congestion control indication associated with the QoS flow is sent by the SMF network element to the access network device, to enable the access network device to perform congestion control on the QoS flow which is associated with the congestion control indication. Therefore, effective congestion control can be provided since the QoS flow on which the congestion control is performed by the access network device is indicated by the SMF network element.

The processor, the apparatus for congestion control or the chip may be an integrated circuit chip with a signal processing capability. In implementation, the operations of the above method embodiments may be accomplished by an integrated logic circuit of the hardware in the processor or the instructions in the form of software. The processor, the apparatus for congestion control or the chip described above may include any one of or an integration of many of: a general purpose processor, an application specific integrated circuit (ASIC), a digital signal processor (DSP), a digital signal processing device (DSPD), a programmable logic device (PLD), a field programmable gate array (FPGA), a central processing unit (CPU), a graphics processing unit (GPU), and an embedded neural-network processing unit (NPU), a controller, a microcontroller, a microprocessor, a programmable logic device, a discrete gate or a transistor logic device, a discrete hardware component. The methods, operations and logic block diagrams disclosed in embodiments of the disclosure may be implemented or performed. The general purpose processor may be a microprocessor, or may be any conventional processor or the like. The operations of the methods disclosed combined with embodiments of the disclosure may be directly embodied as execution of a hardware decoding processor, or execution of a combination of a hardware module and a software module in the decoding processor. The software module may be located in a random access memory (RAM), a flash memory, a read-only memory (ROM), a programmable ROM (PROM), an electrically erasable PROM (EEPROM), a register and another storage media mature in the art. The storage medium is located in the memory, and the processor reads information in the memory and completes the operations of the method described above in combination with its hardware.

It is understood that the memory or the computer storage medium in embodiments of the disclosure may be a volatile memory or a non-volatile memory, or include both a volatile and a non-volatile memory. The nonvolatile memory may be an ROM, a PROM, an erasable PROM (EPROM), an EEPROM, or a flash memory. The volatile memory may be an RAM which serves as an external cache. By way of example but not limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink SDRAM (SLDRAM), and a direct rambus RAM (DR RAM). It should be noted that the memory of the systems and methods described herein is intended to include but not limited to these and any other suitable types of memories.

It should be understood that the memory or the computer storage medium described above is exemplary, but not limiting. For example, the memory in embodiments of the disclosure may also be an SRAM, a DRAM, an SDRAM, a DDR SDRAM, an ESDRAM, an SLDRAM, and a DR RAM, and the like. That is to say, the memory in embodiments of the disclosure is intended to include but not limited to these and any other suitable types of memories.

Those of ordinary skilled in the art will appreciate that units and algorithm operations of various examples described in connection with the embodiments disclosed herein may be implemented in electronic hardware or a combination of computer software and electronic hardware. Whether these functions are performed in hardware or software depends on the specific application and design constraints of the technical solutions. Professionals may use different methods for each specific application to implement the functions described, but such implementation should not be considered beyond the scope of the disclosure.

Those skilled in the art will clearly appreciate that, for convenience and conciseness of description, the specific operating processes of the systems, the devices and the units described above may refer to the corresponding processes in the aforementioned method embodiments and will not be elaborated herein again.

In several embodiments provided in the disclosure, it should be understood that the disclosed systems, devices, and methods may be implemented in other ways. For example, the device embodiments described above are only schematic. For example, the partition of the unit is only a logical functional partition, which may be implemented in another partition way in practice. For example, the multiple units or components may be combined or integrated into another system, or some features may be omitted or not implemented. On the other hand, the shown or discussed coupling or direct coupling or communication connection between each other may be indirect coupling or communication connection through some interfaces, devices or units, and may be electrical, mechanical or other forms.

The units illustrated as separate elements may or may not be physically separated, and the components displayed as units may or may not be physical elements, i.e. they may be located in one place, or be distributed over multiple network units. Part or all of the units may be selected as actual needs to achieve the purpose of the solution in the embodiment.

In addition, the functional units in various embodiments of the disclosure may be integrated in one processing unit, each unit may exist physically alone, or two or more units may be integrated in one unit.

The functions may be stored in a computer readable storage medium if implemented in the form of software functional units and sold or used as a stand-alone product. Based on this understanding, technical solutions of the disclosure in nature or the part of the technical solutions that contributes to the related art or the part of the technical solutions may be embodied in the form of a software product stored in a storage medium. The storage medium includes instructions which causes a computer device (which may be a personal computer, a server, or a network device, etc.) to execute all or part of the operations in the methods described in various embodiments of the disclosure. The aforementioned storage medium includes various mediums capable of storing program codes, such as a U disk, a removable hard disk, an ROM, an RAM, a magnetic disk or an optical disk.

The above description is only the specific embodiments of the disclosure, however, the scope of protection of the disclosure is not limited thereto. Any change or replacement obvious to the skilled person familiar with the technical field within the technical scope disclosed by the disclosure shall be covered within the scope of protection of the disclosure. Therefore, the scope of protection of the disclosure should be subject to the scope of protection of the claims.

1. An apparatus for congestion control, comprising:
a transceiver, configured to receive a policy and charging control (PCC) rule from a policy control function (PCF) network element, wherein the PCC rule comprises a first congestion control indication; and
a processor, configured to determine a quality of service (QOS) flow for transmitting a first service data flow based on the first congestion control indication;
wherein the transceiver is further configured to send a congestion control indication associated with the QoS flow and a QoS flow identifier of the QoS flow to an access network device.

2. The apparatus of claim 1, wherein the PCC rule further comprises description information of the first service data flow associated with the first congestion control indication.

3. The apparatus of claim 2, wherein the first congestion control indication is used for indicating to enable congestion control on the service data flow corresponding to the description information.

4. The apparatus of claim 1, wherein the first congestion control indication comprises an explicit congestion notification (ECN) or a low latency, low loss, scalable throughput (L4S).

5. The apparatus of claim 1, wherein,
the QoS flow for transmitting the first service data flow is an existing first QoS flow, and the congestion control indication associated with the first QoS flow is the same as the first congestion control indication; or
the QoS flow for transmitting the first service data flow is a second QoS flow newly created by a session management function (SMF) network element, and a congestion control indication associated with the second QoS flow is the same as the first congestion control indication.

6. The apparatus of claim 1, wherein
in case that the first congestion control indication is different from all congestion control indications associated with existing one or more QoS flows, the QoS flow for transmitting the first service data flow is a second QoS flow newly created by the SMF network element; or
in case that each of existing one or more QoS flows is not associated with a congestion control indication, the QoS flow for transmitting the first service data flow is a second QoS flow newly created by the SMF network element.

7. The apparatus of claim 1, wherein the PCC rule further comprises: a QoS requirement of the first service data flow, and
the processor is further configured to determine the QoS flow for transmitting the first service data flow based on the QoS requirement of the first service data flow and the first congestion control indication.

8. The apparatus of claim 7, wherein
the QoS flow for transmitting the first service data flow is an existing first QoS flow, the congestion control indication associated with the first QoS flow is the same as the first congestion control indication, and a QoS flow requirement corresponding to the first QoS flow is the same as the QoS requirement of the first service data flow; or
the QoS flow for transmitting the first service data flow is a second QoS flow newly created by the SMF network element, the congestion control indication associated with the second QoS flow is the same as the first congestion control indication, and a QoS flow requirement corresponding to the second QoS flow is the same as the QoS requirement of the first service data flow.

9. The apparatus of claim 7, wherein the QoS requirement comprises at least one of:
a 5th generation (5G) QoS identifier, an allocation priority, a bit rate requirement, a time-delay requirement for transmission, or a bit error rate requirement for transmission.

10. An apparatus for congestion control, comprising:
a transceiver, configured to receive a congestion control indication associated with a quality of service (QOS) flow and a QoS flow identifier of the QoS flow from a session management function (SMF) network element; and
a processor, configured to enable congestion control on the QoS flow.

11. The apparatus of claim 10, wherein the congestion control indication associated with the QoS flow comprises an explicit congestion notification (ECN) or a low latency, low loss, scalable throughput (L4S); and
the processor is further configured to: enable ECN congestion control on the QoS flow associated with the ECN; or enable L4S congestion control on the QoS flow associated with the L4S.

12. An apparatus for congestion control, comprising:
a transceiver, configured to send a policy and charging control (PCC) rule to a session management function (SMF) network element, wherein the PCC rule comprises a first congestion control indication.

13. The apparatus of claim 12, wherein the PCC rule further comprises description information of a first service data flow associated with the first congestion control indication.

14. The apparatus of claim 13, wherein the first congestion control indication is used for indicating to enable congestion control on a service data flow corresponding to the description information.

15. The apparatus of claim 13, wherein the transceiver is further configured to:
receive the first congestion control indication and the description information of the first service data flow associated with the first congestion control indication from an application function (AF) entity; and/or
receive a service requirement of the first service data flow from the AF entity.

16. The apparatus of claim 12, wherein the first congestion control indication comprises an explicit congestion notification (ECN) or a low latency, low loss, scalable throughput (L4S).

17. The apparatus of claim 13, wherein the description information comprises at least one of: packet header information, an application identifier, or a service identifier; and
the packet header information comprises at least one of: a source Internet protocol (IP) address, a destination IP address, a source port, a destination port, a source media access control (MAC) address, or a destination MAC address.

18. The apparatus of claim 13, wherein the PCC rule further comprises a quality of service (QOS) requirement of the first service data flow, and the QoS requirement of the first service data flow is determined based on a service requirement of the first service data flow.

19. The apparatus of claim 18, wherein the QoS requirement comprises at least one of:
a 5th generation (5G) QoS identifier, an allocation priority, a bit rate requirement, a time-delay requirement for transmission, or a bit error rate requirement for transmission.

20. The apparatus of claim 18, wherein the service requirement comprises at least one of:
a service type, a bit rate requirement for service, a time-delay requirement for transmission, a priority requirement for transmission, or a bit error rate requirement for transmission.
